(19) United States
(12) Patent Application Publication
(10) Pub. No.: US 2007/0000516 A1
(43) Pub. Date: Jan. 4, 2007

(54) Device and method for cleaning the edges of substrates

(76) Inventors: Christian Krauss, Neulingen-Bauschidt (DE); Karl Appich, Diefenbach (DE); Jakob Szekeresch, Schonberg (DE); Peter Dress, Bruchsal (DE)

Correspondence Address: Roberts W. Becker & Associates, 707 Hwy 66 East Suite B, Tijeras, NM, 87059-7382, US

(21) Appl. No.: 10/575,746

(22) PCT Filed: Oct. 7, 2004
(86) PCT No.: PCT/EP04/11193

§ 371 Date: May 11, 2006

(30) Foreign Application Priority Data
Oct. 8, 2003 (DE) 10346667.3
Oct. 6, 2004 (DE) 1020040480691.3

(51) Int. Cl. B08B 3/02

(52) U.S. Cl. 134/10; 134/21; 134/33; 134/34; 134/902; 134/104.2; 134/148; 134/153

(57) ABSTRACT

A device and method for cleaning the edges of substrates, including at least one cleaning head for receiving at least one nozzle element for supplying medium to a substrate. Formed in a main body of the cleaning head are a medium-suctioning port and an adjoining medium-suctioning duct. The cleaning head also has at least one first flange extending from the main body and having a flat side facing the port and extending essentially perpendicular to a surface of the main body containing the port. The nozzle element is provided on the flange and spaced from the main body, and has at least one outlet port opening in the direction that the flat side faces and directed substantially perpendicular thereto. The outlet port is recessed relative to the flat side or is flush therewith. During a cleaning process, the fat side is spaced by 0.05 to 0.5 mm from the substrate surface.

This invention relates to the removal of materials and/or media from the edges or the peripheral area of substrates (hereinafter referred to as “cleaning the edges”), and in particular to cleaning the edges of substrates in the semiconductor industry.

In the domain of the semiconductor industry, the quality of a production process is determined in particular by the cleanliness of automated procedures and the components used. It is of particular significance here that during the production process, which can comprise a large number of different individual processes, there is no transfer of materials and/or media between the individual processes. An essential contribution to the avoidance of material and/or media transfer is made in that the contact surfaces between apparatus components, such as e.g. a handling system, a cassette, a chuck or a holding device, and the substrate must at all times during the production process be free, as far as possible, from materials and/or media, such as for example solvents, coatings or lacquer. The materials/media could otherwise be transferred from one substrate to the next by the contact with such apparatus components, and then contaminate said substrate.

In order to avoid this type of material and/or media transfer, among other things, following coating processes, the edges of substrates, which here can be for example a photomask or even a semiconductor wafer, are cleaned. Independently of which coating method is used, the edge or side faces and/or also the lower faces of the substrates are contaminated with lacquer following a coating process. Depending upon the further processing of the substrates, it may also be necessary, for example on a coated upper face of the substrate, to remove the lacquer or coating again from one edge of defined width after the coating. The total removal of lacquer from the areas in question or also just partial removal of lacquer may be necessary here. With this type of lacquer removal or cleaning it is of course necessary that the surfaces of the substrate which are not to be cleaned are in no way affected by the cleaning. In particular it should be avoided that a cleaning fluid used for the cleaning comes into contact with areas other than those to be cleaned.

A device for cleaning the edges of a semiconductor wafer is known, for example, from EP 1 067 591 with which the substrate to be cleaned is held on a rotating device, and a fluid nozzle with an angle of incidence of between 0° and 45° is directed towards the peripheral area of the substrate. In order to clean the substrate, it is set in rotation, and an etching fluid is directed onto the peripheral area of the substrate by the fluid nozzle. By means of centrifugal force, the etching fluid applied is substantially guided radially outwards.

This known method is on the one hand only suitable for round substrates, and moreover is associated with the risk that the etching fluid may splash upon hitting the substrate and also get into other areas which are not to be cleaned. Moreover, although this method enables cleaning of a peripheral area on the upper face of the substrate, good cleaning of the side face of the substrate is not possible because the substrate is rotated at high speed, and the cleaning fluid is thrown radially. It therefore only comes insufficiently into contact with the front face of the substrate. This method is in particular also not possible with substrates, such as for example semiconductor wafers with a flattening, i.e. a so-called flat, because in the region of the flat no etching fluid can be directed onto the peripheral area of the wafer during rotation.

Starting with the prior art, the object which forms the basis of this invention is therefore to provide simple and inexpensive cleaning of peripheral areas of substrates, particularly also of substrates that are not round.

According to the invention, this aim is achieved by a device for cleaning edges of substrates, in particular photomasks and/or semiconductor wafers, in that the device comprises at least one cleaning head with at least one media-delivering nozzle and at least one media-suctioning port, and a movement mechanism to produce a relative movement between the cleaning head and a substrate, the cleaning head having a main body in which the media-suctioning port and an adjacent media-suctioning duct are embodied, at least one first flange that is provided with a flat face which points towards the media-suctioning port and extends substantially perpendicular to a side surface of the main body, said side surface containing the media-suctioning port, wherein the at least one media-delivering nozzle is disposed at a distance from the main body on the first flange, has at least one outlet port open to the flat face of the flange, which points towards the media-suctioning port, and is directed substantially perpendicular to the flat face of the flange which points towards the media-suctioning port, wherein the outlet port of the media-delivering nozzle is recessed in relation to the flat face of the flange or is level therewith, and wherein the movement mechanism is controllable so as to maintain a distance of 0.05 to 0.5 mm, especially up to 0.3 mm, and preferably of 0.2 mm, between a surface of the substrate and the flat face of the flange which points towards the substrate surface during the cleaning process. The cleaning head according to the invention makes it possible to partially encompass a substrate to be cleaned, it being possible for the media-suctioning port to be disposed pointing towards a side face of the substrate, whereas the media-delivering nozzle is directed substantially perpendicular to an upper or lower face of the substrate to be cleaned. By means of the media-suctioning port and the adjacent media-suctioning duct, a cleaning fluid applied by the media-delivering nozzle can be directly suctioned so that the risk of the cleaning fluid coming into contact with areas of the substrate other than those to be cleaned is avoided. By disposing the media-delivering nozzle so as to be recessed in relation to the flat face of the flange, or level therewith, a narrow gap can be created between the flat face of the flange and the substrate which guarantees good suctioning of the medium applied. The narrow gap of 0.05 mm to 0.5 mm, especially up to 0.3 mm, also makes it possible to produce a capillary effect, and makes it possible for the cleaning medium to be applied to be substantially unpressurized at the outlet port of the media-delivering nozzle because a negative pressure applied by the media-suctioning port is sufficient in order to draw the medium out of the media-delivering nozzle. The narrow gap further ensures that relatively little ambient air is suctioned, by means of which a relatively low suction force is required in order to achieve a specific flow of the medium applied. The medium can only be drawn out of the media-delivering nozzle by suctioning at the media-suctioning port and moved away over the substrate to the media-suctioning port. Moreover, due to the possibility of directly suctioning the cleaning fluid, it is not necessary to set a substrate to be cleaned in rotation, as in EP 1 067 591 described above, and which requires the rotation in order to spin off the cleaning fluid. It is therefore also possible to clean substrates with straight edges. Furthermore, cleaning of sections or part-areas of the peripheral edges of a substrate is also possible.

The object which forms the basis of the invention is also fulfilled by an alternative device for cleaning the edges of substrates, in particular photomasks and/or semiconductor wafers, which has at least one cleaning head with at least one media-delivering nozzle and at least one media-suctioning port, the cleaning head further comprising the following:

a main body in which the media-suctioning port and an adjacent media-suctioning duct are embodied; a first and second flange that are each provided with a flat face which points towards the media-suctioning port and extends substantially perpendicular to a side surface of the main body, said side surface containing the media-suctioning port, the flat faces of the flanges being parallel to one another, and at least one media-delivering nozzle which is disposed a distance away from the main body on the first flange, has at least one outlet port open to the face of the flange which points towards the media-suctioning port and which is directed substantially perpendicular to the flat face of the first flange which points towards the media suctioning port, wherein the outlet port of the media-delivering nozzle is recessed in relation to the flat face of the flange or is level therewith, and wherein the distance between the parallel faces of the flanges is greater by 0.1 mm to 1 mm, especially up to 0.6 mm, and preferably by 0.4 mm, than the thickness of the substrate to be cleaned.

With this alternative device, the advantages already specified above are substantially achieved. In particular the narrow gap formed between the parallel flat faces of the flanges and a substrate accommodated between them result in a capillary effect which in connection with the suctioning leads to a defined flow of a cleaning medium over a peripheral area of the substrate which makes specific cleaning possible. By means of the two flanges, the substrate can be encompassed by means of which a well-defined suctioning area can be produced.

According to a particularly preferred embodiment of the invention, at least one second flange is provided which has a flat face extending substantially parallel to the flat face of the first flange which points towards the media-suctioning port, a distance between the parallel flat faces of the flanges being greater than the thickness of the substrate to be cleaned. By means of the second flange it is possible to encompass a part peripheral area of a substrate by means of which a well-defined suctioning area can be produced. Preferably, the distance between the flanges is 0.1 mm to 1 mm, especially up to 0.6 mm, and preferably 0.4 mm greater than the thickness of the substrate to be cleaned, by means of which good suctioning of the cleaning fluid is possible, among other things due to the aforementioned capillary effect.

With a particularly preferred embodiment of the invention, at least one further media-delivering nozzle is provided which is disposed at a distance from the main body on the second flange, and is open to the flat face of the second flange which points towards the media-suctioning port and is directed substantially perpendicular to the same. By means of the provision of at least one further media-delivering nozzle, cleaning of the upper and lower face of the substrate at the same time is possible. Furthermore, the two media flows also facilitate cleaning of the side or edge face of the substrate because they can at least partially wet the side face from above and below. The structure of the cleaning head here is preferably symmetrical to a plane lying centrally between the flanges in order to achieve substantially even cleaning conditions on the upper and lower side of the substrate. Preferably, at least one media-delivering nozzle is pivotable on its respective flange so as to enable an adjustment of the width of a peripheral area of the substrate to be cleaned by pivotal movement of said media-delivery nozzle. At least one media-delivering nozzle can pivot on its respective flange between 0° and 40°, preferably between 0° and 20°, in relation to a line perpendicular to the face of the flange which points towards the media-suctioning port, the pivotal movement being in the direction towards the substrate edge.

Preferably, the at least one media-delivering nozzle has a plurality of outlet ports so as to be able to apply fluid over a great width, by means of which among other things, the retention times of the cleaning fluid on the substrate can be increased. With an alternative embodiment, the at least one media-delivering nozzle has a slit-shaped outlet port so as to be able to apply a cleaning fluid to the substrate evenly over a wide area. Preferably, the distance between the at least one outlet port of the media-delivering nozzle and the side surface of the main body of the cleaning head containing the media-suctioning opening is between 2.5 mm and 6 mm, and is especially 3 mm.

The plurality of outlet ports or the slit-shaped outlet port preferably extend parallel to the side surface of the main body of the cleaning head containing the media-suctioning port.

With one embodiment of the invention, at least one media supply, which is connected to at least one media-delivering nozzle, and a control device are provided for regulating the media supply such that during cleaning, the medium is in an unpressurized condition at the at least one outlet port of the at least one media-delivering nozzle. Because the medium is substantially unpressurized, the medium is applied substantially exclusively by means of a negative pressure formed at the media-suctioning port, which draws the medium out of the media-delivering nozzle. In this way it is guaranteed that only the amount of medium is applied as is also suctioned by the media-suctioning port. Moreover, a positive air flow results in the direction of the media-suctioning port which guarantees that the medium does not reach a central area of the substrate. Furthermore, the medium hits a surface of the substrate substantially without any force, by means of which splashing of the same is prevented.

It is alternatively also possible to convey a medium, such as for example a cleaning fluid, through the media-delivering nozzle with pressure and to apply it to the substrate to be cleaned. The medium is conveyed through the media-delivering nozzle here with a relatively low pressure of between 10 KPa and 30 KPA, preferably 20 KPa, so as to prevent it from splashing when it hits the substrate. Even if small splashes occur, these are however prevented from getting into a media area of the substrate which is not to be cleaned due to the narrow capillary gap between the flange and the substrate and the air flow.

In order to make possible selective cleaning of the upper and/or lower face of the substrate, a control device is preferably provided for separately controlling the media-delivering nozzles. As well as selective cleaning of the upper and lower face, by means of the separate control it is also possible to provide different processes on the upper and lower face.

Preferably, the at least one flange of the cleaning head has a recess in which the media-delivering nozzle is at least partially disposed. By means of the media-delivering nozzle being disposed in a recess, said nozzle is at least partially surrounded by the flange so as to form a suctioning slit between the substrate on the one hand and the flange and the media-delivering nozzle on the other hand over a large area.

With the preferred embodiment of the invention, the media-suctioning port is circular in form, the diameter preferably being larger by approximately 0.2 mm than the thickness of the substrate to be cleaned. In this way good suctioning of the medium is guaranteed. Preferably, the media-suctioning duct tapers away from the media-suctioning port.

Advantageously, a suctioning device connected to the media-suctioning duct and a control device for controlling the same are provided. By controlling the suctioning device, the retention time of the cleaning medium on the substrate, and the suctioned quantity of media, can be set.

In order to make it possible to clean the edges of the substrate along an edge of the same, a substrate support for a substrate and a device for producing a relative movement between the substrate support and the cleaning head are preferably provided. Preferably, a control device for setting on overlap-degree of the at least one flange with a side face of the substrate is provided here in order in this way to provide setting of the width of the edge to be cleaned. Preferably, a control device is also provided to control a relative movement between the cleaning head and the substrate such that the cleaning head runs along at least one part area of at least one edge of the substrate, maintaining a constant distance. In this way, a defined part area of the edge of the substrate can be cleaned.

The object which forms the basis of the invention is fulfilled by a method for cleaning the edges of substrates, in particular photomasks and/or semiconductor wafers, by disposing a cleaning head with at least one media-delivering nozzle and at least one media-suctioning port adjacent to a substrate such that the media-delivering nozzle is directed towards at least one peripheral area of a main face of the substrate to be cleaned, and the media-suctioning port lies in the area of the media-delivering nozzle adjacent to a side or edge face of the substrate, a distance between a flat face of a flange of the cleaning head carrying the media-delivering nozzle and the peripheral area of the substrate to be cleaned being set to 0.05 to 0.5 mm, especially up to 0.3 mm, and preferably to 0.2 mm; applying a cleaning fluid to the peripheral area of the substrate with the at least one media-delivering nozzle; and drawing off or suctioning of the complete cleaning fluid by means of the media-suctioning port and an adjacent media-suctioning duct. By means of the method according to the invention, the advantages already specified above are achieved. In particular, the provision of the narrow gap between the flange and the main face of the substrate facilitates specific application and suctioning of the medium applied.

Preferably, the cleaning head has at least two media-delivering nozzles which point towards one another, and the peripheral area of the substrate to be cleaned is disposed between at least two media-delivering nozzles during the disposing step. In this way it is possible for the media-delivering nozzles to be directed respectively towards the upper and lower face of the substrate, and the media-suctioning port lies adjacent to the side face of the substrate. With this arrangement, both the upper and the lower face of the substrate can be cleaned at the same time. Furthermore, in this way, improved cleaning of the side face of the substrate can also be achieved because the medium applied for this can be brought from both main faces of the substrate so as to wet the side face before it is drawn in the direction of the media-suctioning. This is made possible among other things by the narrow gap formation which makes possible the application of a relatively low suctioning force because hardly any ambient air is suctioned or drawn in. The low suctioning force once again makes possible good wetting of the front face of the substrate.

With a preferred embodiment of the invention, the cleaning fluid is supplied to the at least one media-delivering nozzle such that it is substantially unpressurized at an outlet port of the same, and is drawn out of the at least one media-delivering nozzle via the media-suctioning port and the adjacent media-suctioning duct substantially by the suctioning force, and applied to the peripheral area of the substrate to be cleaned. In this way it is guaranteed that only the respective amount of cleaning fluid is applied to the substrate as is suctioned by the media-suctioning port. Moreover, the fluid hits the substrate substantially without any force.

With an alternative embodiment of the invention, the cleaning fluid is applied to the peripheral area of the substrate to be cleaned by the media-delivering nozzle with pressure. This is especially advantageous when the distance between the media-delivering nozzle and the substrate is too great for it to be possible to apply a sufficient negative pressure at the outlet port of the media-delivering nozzle in order to draw out the cleaning fluid. The pressure should be kept relatively low so as to prevent the media from splashing when it hits the substrate. For this, the pressure preferably falls within a range of between 10 KPa and 30 KPa, and preferably 20 KPa.

Preferably, the cleaning fluid is applied substantially perpendicular to the peripheral area of the substrate. With one embodiment of the invention, the cleaning fluid is applied to the peripheral area of the substrate with an angle which deviates from a vertical to the substrate surface by 0° and 40°, and preferably between 0° and 20°, the cleaning fluid being applied to the edge of the substrate. By means of the angle adjustment, the depth of the peripheral area to be cleaned can be set.

Preferably, the media-delivering nozzles are controlled separately, by means of which it can be guaranteed on the one hand that even pressure is present at the outlet ports of the media-delivering nozzles which point in opposite directions. Furthermore, it is possible to subject the media-delivering nozzles to different pressures so as, for example, to convey different quantities of fluid to the upper and lower face of the substrate. Furthermore, it is also possible to apply different fluids to the media-delivering nozzles. For example, a solvent could be applied to the upper face of the substrate, whereas pure water is applied to the lower face, by means of which corresponding fluid flows are formed, and it is guaranteed that the solvent does not get onto the lower face of the substrate.

With a particularly preferred embodiment of the invention, the media-delivering port and the media-suctioning port are moved along at least a part area of at least one edge of the substrate in order to undertake edge cleaning in this part area. The distance between the media-suctioning port and the side face of the substrate during treatment is preferably kept constant here so as to clean an even peripheral area of the substrate. Preferably, the relative movement between the substrate and the cleaning head is brought about by a movement of the substrate and/or the cleaning head.

In order to achieve good wetting of the side face of the substrate, and thus also good cleaning of the same, the distance between the media-suctioning port and the side face of the substrate during the edge cleaning is preferably set between 0.5 mm and 2 mm, and especially 1 mm. Preferably, a peripheral area of the substrate of between 2 mm and 5 mm, especially 3 mm, is cleaned.

The depth of a peripheral area to be cleaned is advantageously achieved by setting an overlap degree of the at least one media-delivering nozzle with a main face of the substrate. In addition and/or alternatively, the depth of a peripheral area of the substrate to be cleaned can also be achieved by pivoting the media-delivering nozzle.

In order to guarantee that the cleaning fluid is fully suctioned at the end of a cleaning process, application of the cleaning fluid is first of all stopped, and the suctioning of the cleaning fluid is ended after a predetermined period of time after the application of the cleaning fluid has finished.

If the media-delivering nozzle reaches a corner area of the substrate when being moved along the edge of the substrate, the media supply is interrupted before it reaches the corner, whereas suctioning of the cleaning fluid continues. In this way it is guaranteed that the cleaning fluid is furthermore fully suctioned because the suctioning effect can decrease in the corner area. The supply of the media to the media-delivering nozzle is controlled such that the medium just reaches the corner area so that cleaning of the whole edge of the substrate is possible. Preferably, the media supply and/or the suctioning of the cleaning fluid is controlled dependent upon the substrate contour so as to provide defined cleaning of the substrate, in particular where there are transitions between different edge areas.

In the following, the invention is described in greater detail by means of a preferred example of an embodiment, with reference to the drawings. In the drawings:

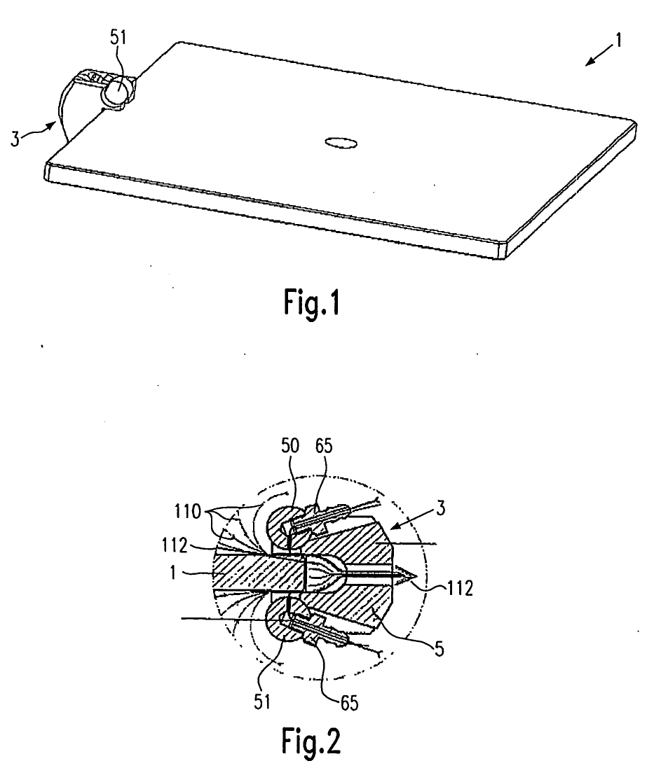

FIG. 1 shows a perspective view of a photomask and a cleaning head according to this invention;

FIG. 2 shows a schematic sectional view through a cleaning head according to FIG. 1;

FIG. 3 shows a front view of the cleaning head without the nozzles attached to it;

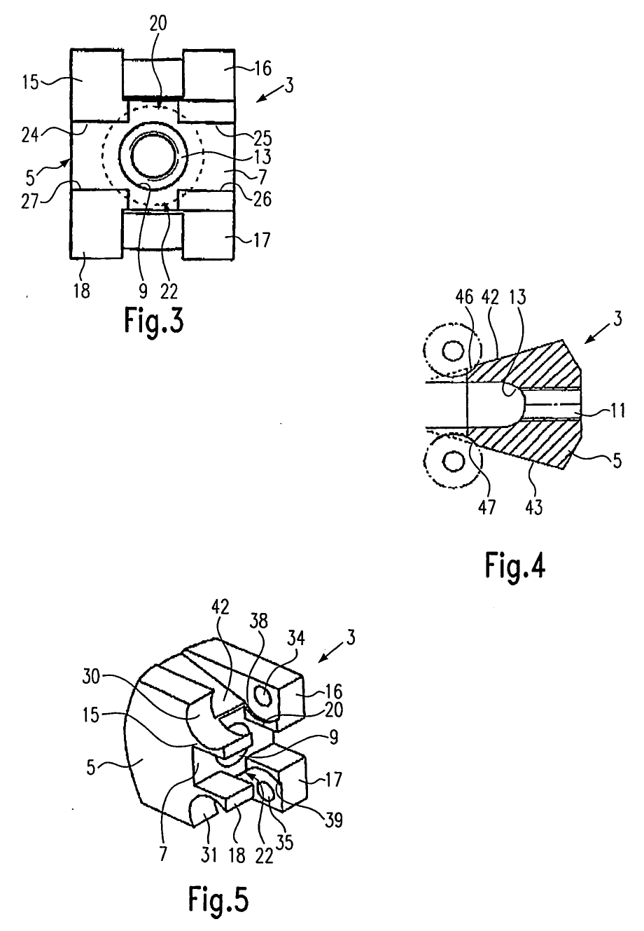

FIG. 4 shows a schematic sectional view through the cleaning head according to FIG. 3;

FIG. 5 shows a perspective view of the cleaning head according to FIG. 3;

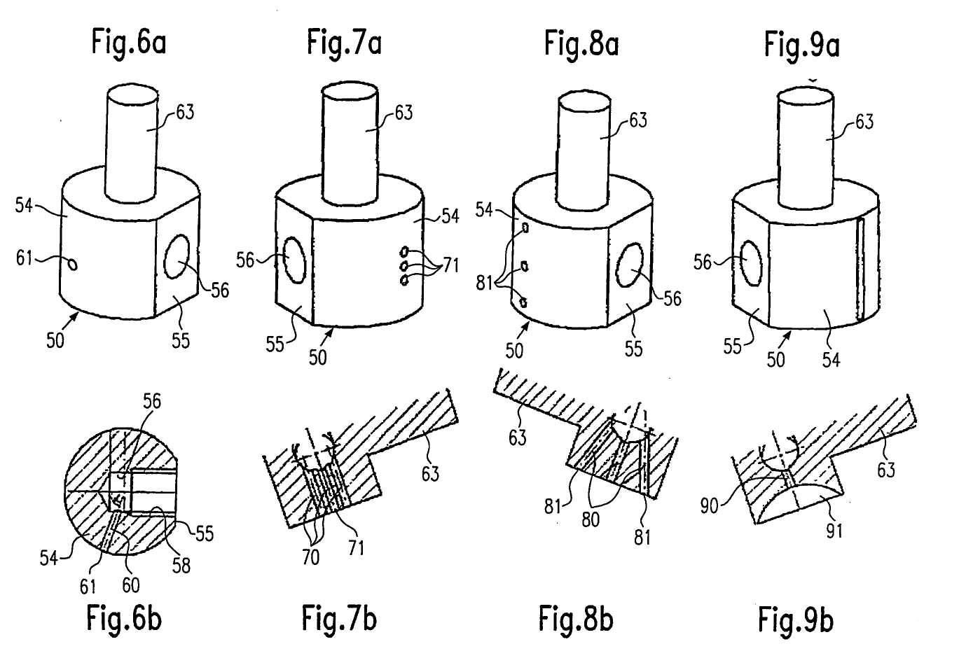

FIGS. 6a and 6b show a perspective and a sectional view of a nozzle body according to a first example of an embodiment of the invention;

FIGS. 7a and 7b show a perspective and a sectional view of a nozzle body according to a second example of an embodiment of the invention;

FIGS. 8a and 8b show a perspective and a sectional view of a nozzle body according to a third example of an embodiment of the invention;

FIGS. 9a and 9b show a perspective and a sectional view of a nozzle body according to a fourth example of an embodiment of the invention;

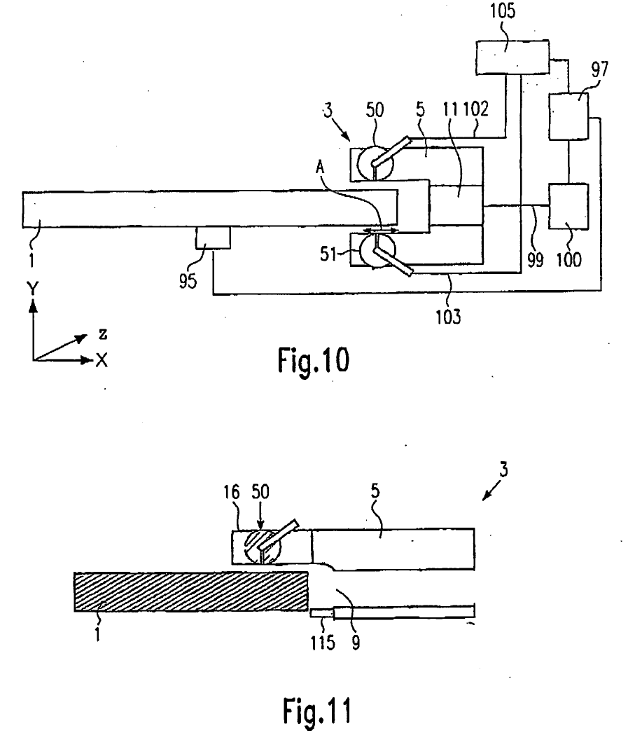

FIG. 10 shows a schematic representation of a cleaning device according to the invention;

FIG. 11 shows a schematic representation of an alternative cleaning head according to this invention.

FIG. 1 shows a perspective view of a photomask 1 and of a cleaning head 3 for cleaning the edges of the photomask 1. FIG. 2 shows an enlarged sectional view of the cleaning head 3, a part of the photomask 1 also being visible. FIGS. 3, 4 and 5 in turn show a front view, a sectional view and a perspective view of the cleaning head 3, parts of the cleaning head being left out in FIGS. 3 and 5, as will be described in more detail in the following. The structure of the cleaning head 3 is described in greater detail by means of FIGS. 1 to 5. With the following description, the terms upper, lower, rear, front and similar terms are used in consideration of the representation of the drawing, these terms however in no way being limited because they depend upon the respective alignment of the cleaning head.

The cleaning head 3 is provided with a main body part 5 which has a substantially flat side surface 7. On the flat front face 7, a port 9 is provided which is connected to a media-suctioning duct 11. The port 9 has a round diameter which decreases towards the media-suctioning duct 11. The reduction of the diameter is brought about by a curved wall section 13 of the main body 5.

Furthermore, the cleaning head 3 has a total of four flanges 15 to 18 extending from the main body 5. The flanges 15 to 18 extend from the main body 5 such that they project over the flat face 7. The flanges 15 and 16 extend at an upper end of the main body 5, and the flanges 17 and 18 extend at a lower end of the main body 5, as can be best seen in FIGS. 3 and 5. At the upper end, the flanges 15 and 16 are spaced apart from one another and form between them an empty space or a recess 20. In the same way, an empty space or a recess 22 is formed between the lower flanges 17, 18. According to the front view in FIG. 3, the flanges 15 to 18 are provided at the four corners of the main body 5.

The flanges 15 and 16 each have a straight or flat lower face 24 and 25 extending perpendicular to the flat face 7. Correspondingly, the flanges 17 and 18 each have an upper face 26, 27 pointing upwards, and extending substantially perpendicular to the flat face 7. The lower faces 24, 25 thus lie parallel to the upper faces 26 and 27. The distance between the lower faces 24, 25 and the upper faces 26, 27 is adapted to the size of a substrate to be cleaned, and is about 0.2 mm to 1 mm, preferably 0.4 mm, greater than the thickness of the substrate to be cleaned. With the substrate inserted, a respective capillary gap of between 0.1 and 0.5, preferably of 0.2 mm, is thus formed between the main faces of the substrates and the lower face of the flanges 17 and 18 and the upper face of the flanges 24 and 25 respectively. Dependent upon the application, it is also possible to choose the distance between the flanges to be about 0.1 mm greater than the thickness of the substrate, by means of which a respective capillary gap of 0.05 mm would be formed.

The flanges 15 and 18 each have a round recess 30 and 31 open to the top or to the bottom, the function of which will be described in more detail below. On the other hand, the flanges 16 and 17 do not have a recess which points upwards or downwards. However, the flanges 16 and 17 have a borehole 34, 35 pointing towards the flanges 15, 18. Moreover, the flanges 16 and 17 each have a round shoulder surface 38, 39 which points upwards or downwards. The shoulder surfaces 38, 39 are formed respectively on the sides of the flanges 16 and 17 pointing towards the flanges 15 and 18. The function of the boreholes 34, 35 and of the shoulder surfaces 38, 39 are described in greater detail below.

In areas of the main body lying between the flanges 15, 16 and between the flanges 17, 18, said areas have a respective slant 42 and 43 tapering conically towards the flat surface 7, as can best be seen in FIG. 4 and FIG. 5. On the front end of the slant 42 of the main body 5 a rounded portion 46 open to the top is provided, whereas at the front end of the incline 43, a rounded portion 47 open to the bottom is provided. The function of the curves 46 and 47 is described in greater detail below.

Furthermore, the cleaning head 3 has two rotatable nozzle elements 50, 51 mounted on the flanges 15, 16 and 17, 18, as can best be seen in FIG. 2. The nozzle elements 50 and 51 have the same structure and so only nozzle element 50 is described in greater detail. The basic structure of the nozzle element 50 is described in greater detail by means of FIG. 2 and FIGS. 6a and 6b which show a perspective view and a sectional view of a nozzle element 50 according to a first example of an embodiment. The nozzle element 50 has a substantially circular cylindrical main element 54. However, the main element 54 is not perfectly circularly cylindrical in form because the circular shape has a flattening or flat face 55, as can best be seen in the sectional view according to FIG. 6b. In the main element 54 a blind hole 56 is provided which extends perpendicular to the flat face 55 and which extends out from the flat face 55 into the main element 54. In a front area, i.e. lying adjacent to the flat face 55, the blind hole 56 has an internal thread 58. An area without a thread adjoins the inner thread 58 towards the inside, i.e. adjacent to the inner end of the blind hole.

Furthermore, a branch bore 60 is provided in the main element 54 which intersects a central axis of the blind hole with an angle a of approximately 500. The branch bore 60 intersects the blind hole 56 in the area in which no internal thread 58 is provided. The branch bore 60 connects the inner end of the blind hole 56 to a circular outer periphery of the main element 54. The branch bore 60 forms an outlet port 61 of the nozzle element 50, as described in greater detail below. Furthermore, the nozzle element 50 has a circular cylindrical mounting pin 63 extending from a side face of the cylindrical main element 54. A central axis of the circular cylindrical mounting pin 63 coincides with the central axis of the circular part of the substantially circular main element 54.

As can be best seen in FIG. 2, the thread 58 serves to accommodate a tube or hose attachment element 65 which has a corresponding external thread and can be screwed into the blind hole 56. By means of this attachment element 65, a media-delivering line can be connected to the nozzle element 50.

Correspondingly, the nozzle element 51 according to FIG. 2 can be also be connected to a media-delivering line, not shown in detail, by means of a corresponding attachment element 65.

The guide pin 63 is of dimensions such that it fits into the bore hole 34 of the flange 16 and makes possible pivotal mounting of the nozzle element 50 therein. The shoulder 38 on the flange 16, the rounded portion 46 on the front end of the slant 42, and the round recess 30 on the flange 15 are respectively of dimensions such that they provide a guide for a part of the circular cylindrical part of the main element 54. The nozzle element 50 is substantially installed here such that the flat face 55 substantially forms a right angle to the slant 42 and the branch bore 60 extends substantially perpendicular to the lower face 24 and 25 of the flanges 15 and 16. Furthermore, the nozzle element is installed such that it is slightly recessed in relation to the flat lower faces of the flanges 16, 17, it also being possible, however, to install the nozzle element 50 and in particular its outlet port flush with the straight lower faces of the flanges. Preferably, it should be avoided that the nozzle element projects over the lower side of the flanges.

The nozzle element 51 is correspondingly fixed to the flanges 17, 18. The cleaning head 3 thus has a structure which has its mirror image in relation to a horizontal central plane.

FIGS. 7 to 9 shows alternative embodiments of a nozzle element 50. In FIGS. 7 to 9 the same reference numbers are respectively used as with the nozzle element according to FIG. 6 in so far as similar or identical components are being described.

The nozzle elements 50 according to examples of embodiments 7 to 9 each have a substantially circular cylindrical main element 54 which has a flat face 55 which cuts into the circular cylindrical form. On the flat face 55 a blind hole 56 extending perpendicular thereto is respectively provided in which an attachment element, such as for example the attachment element 65 according to FIG. 2, can be installed. The blind hole 56 respectively has the same structure as shown in FIG. 6b.

Furthermore, the nozzle elements of the embodiments according to FIGS. 7 to 9 each have a circular cylindrical guide pin 63, the central axis of which coincides with the central axis of the circular cylindrical part of the main element 54.

The respective embodiments of the nozzle elements according to FIGS. 7 to 9 differ from the example of an embodiment of the nozzle element 50 according to FIG. 6 substantially only with regard to a connection between an internal area of the blind hole 56 and the outer periphery of the cylindrical part of the main element 54. The embodiment according to FIG. 6 is provided with a single branch bore 60, which is provided with an outlet port 61. The embodiment according to FIG. 7 has a total of three branch bores 70, which each define an outlet port 71. The three branch bores 70 are disposed parallel to one another, and connect the blind hole to the external periphery of the main element 54. The outlet openings 71 respectively serve as outlet nozzles for a medium conveyed into the blind hole 56.

The embodiment according to FIG. 8 once again has three branch bores 80, which each define outlet ports 81. In the embodiment according to FIG. 8, the branch bores 80 do not run parallel to one another, but extend from the blind hole in a fan shape to the external periphery of the main element 54. As can be clearly seen by comparing FIGS. 7 and 8, in this way the distance between the outlet ports 81 is clearly increased with respect to the distance between the outlet ports 71. In this way it is possible for a fluid coming out through the branch lines 80 to be distributed over a wide area.

The embodiment according to FIG. 9 has a single branch bore 90, which connects the blind hole 56 to a concave slit 91 and not directly to the outer periphery of the main element 54. The concave slit 91 is open to the outer periphery of the main element 54, and serves as a slit-shaped outlet port.

FIG. 10 shows a schematic structure of a cleaning device according to this invention. In FIG. 10 a photomask 1 and the cleaning head 3 can be seen. The photomask 1 is located on a support 95 which can move in directions X, Y and Z, as indicated by the coordinate system in FIG. 10. Moreover, the support 95 can rotate around the Z-axis. The support 95 is connected to a control device 97 which controls the movement of the support 95. Alternatively, it is also possible to provide a stationary support 95, and instead of this to design the cleaning head 3 to be movable. Of course it is also possible to design both the support 95 and the cleaning head 3 to be movable.

The media-suctioning duct 11 in the main body part 5 in the cleaning head 3 is connected by a corresponding line 99 to a suction device, such as for example a pump 100. The pump 100 is connected to the control device 97 and is controlled by this.

The nozzle elements 50, 51 and the corresponding hose attachment elements 65 are respectively connected to a media supply 105 by means of corresponding lines 102, 103. The lines 102, 103 can be controlled separately from one another by the media supply. The media supply 105 is connected to the control device 97, and is controlled by the same. Of course it is also possible to control the lines 102, 103 together.

The operation of the cleaning device is described in greater detail below by means of the figures, in particular by means of FIG. 10.

First of all a substrate, such as for example the photomask 1, is deposited on the support 95. The support 95 is then moved such that a peripheral area of the photomask 1 is accommodated centrally between the upper flanges 15, 16 and the lower flanges 17, 18 of the cleaning head 3, as can be seen in FIG. 10. By means of the distance between the upper and lower flanges, a capillary gap is respectively formed between the main faces of the substrate and the flat lower and upper faces of the flanges 15 to 18. The overlap between the photomask and the flanges is set such that the nozzle port 61 is directed towards the upper and the lower face of the photomask with a distance A from a side face of the photomask 1. The distance A corresponds to the peripheral area of the photomask 1 to be cleaned. The distance A, which corresponds to the peripheral area of the photomask 1 to be cleaned can moreover also be set by rotating the nozzle elements 50 and 51. This makes it possible to also provide a different setting for distance A on the upper face in comparison to the lower face of the photomask 1.

Then, an appropriate cleaning medium, such as for example a solvent, is supplied to the outlet ports of the nozzle elements 50 and 51 by the media supply 105. The cleaning fluid here is supplied such that it is substantially unpressurized at the respective outlet port or ports. Next, the pump 100 is activated so as to produce a flow in the direction of the media-suctioning port 9 and the media-suctioning duct 11. This air flow is best demonstrated by the arrows 110 in FIG. 2. By means of this flow a negative pressure is produced at the outlet ports of the nozzle elements 50, 51 which draws the cleaning fluid out of the respective outlet ports and brings it into contact with the upper and lower face of the photomask 1 and the upper flanges 15, 16 and the lower flanges 17, 18 of the cleaning head 3 where the medium can spread out specifically by means of the capillary gap. The cleaning fluid flows through the capillary gap along the upper and lower face of the photomask 1, and due to its wetting capability it also wets the side face of the photomask 1 and comes into contact with the same. The wetting can be facilitated by setting a relatively low suctioning force which once again is made possible due to the narrow gaps between the flanges and the main faces of the substrate. A combined air/fluid mixture is then suctioned from the photomask 1, as indicated by 112 in FIG. 2. This air/fluid mixture is disposed of appropriately. After the start of a corresponding flow of cleaning fluid, the photomask 1 is moved relative to the cleaning head 3 such that the cleaning head travels along an edge of the photomask 1, maintaining a constant distance. The movement is continued until a desired edge area is cleaned. If the whole edge is to be cleaned, the movement is continued up to the corner of the photomask 1 or beyond it. In order to guarantee that a sufficient suctioning force is available for the cleaning fluid in the corner areas, and that not too much cleaning fluid is conveyed onto the photomask, the media supply can be stopped shortly before reaching a corner. Alternatively or in addition, the suctioning force of the pump 100 can be furthermore increased in the corner area.

If a further edge of the photomask 1 is to be cleaned, it can be rotated by the support 95 and a further edge can undergo cleaning. Of course it is also possible to provide more than one cleaning head in order to clean for example opposite edges with the same movement of the photomask 1.

Although with the example of an embodiment described above the photomask 1 was moved in order to achieve edge cleaning, it is of course also possible to move the cleaning head 3 along the edges of the photomask 1. It is of course also possible here to provide more than one cleaning head. For example, a total of four cleaning heads 3 could be provided in order to clean all of the edges of the photomask 1 at the same time.

At the end of a corresponding cleaning process, the media supply is stopped, and then the pump 100 is also stopped in order to end the suctioning process. In general, the media supply is stopped first here, and the suctioning process is then maintained for a short time so as to ensure that all of the cleaning fluid is suctioned.

The above process can of course also be used correspondingly on other substrates, such as for example semiconductor wafers, in particular semiconductor wafers with a so-called flat. The cleaning head can substantially be moved along any form. With predominantly round substrates, the flat surface 7 of the cleaning head 3 can have a curved shape adapted to the peripheral shape of the substrate. Furthermore, the media supply and/or the suctioning of the cleaning fluid can be controlled dependent upon the contour of the substrate so as also to provide defined cleaning in areas of transitions between different contour areas, e.g. flat/curve.

FIG. 11 shows an alternative embodiment of a cleaning head 3, the same reference numbers being used in FIG. 11 as in the preceding Figures, in so far as the same or similar elements are indicated. The main difference between the cleaning head 3 according to the first example of an embodiment and the cleaning head 3 according to FIG. 11 lies in that flanges 15, 16 are only provided on an upper face of a main element 5, only the flange 16 being seen in FIG. 11.

With the example of an embodiment according to FIG. 11, no lower flanges are provided; instead of this, a projection 115 is provided on the main element 5 below a media-suctioning port 9.

A corresponding nozzle element 50 is once again held on the upper flanges 15, 16.

Operation of the nozzle element 3 according to FIG. 11 substantially 15 corresponds to operation of the nozzle element 3 according to the preceding embodiment, cleaning only being provided on one side, however, on the upper side of a substrate, such as for example a photomask 1. It is important here that a capillary gap with a width of between 0.05 and 0.5 mm, especially between 0.1 mm and 0.3 mm is once again produced between the upper flanges 15, 16 and the upper face of the substrate so as to guarantee a controlled flow of medium in the direction of the media-suctioning port. The projection 115 serves to limit a flow of air from below into the media-suctioning port and the adjacent media-suctioning duct during operation.

In the description of the operation of the device according to the invention, the cleaning fluid was supplied to the corresponding nozzle elements 50, 51 during cleaning such that the fluid was substantially in an unpressurized condition at the respective outlet ports of the nozzle elements 50. The cleaning fluid was thus applied to the fluid passively by means of a negative pressure resulting from suctioning of air. Of course it is also possible to apply the cleaning fluid actively to a corresponding substrate, in that the media supply 105 is controlled such that the fluid comes out of the outlet ports of the nozzle elements 50, 51 under pressure. The pressure should be kept relatively low in a range of between 10 KPa and 30 KPa, preferably 20 KPa, so as to prevent it from splashing when it hits the substrate and in this way getting into a central area, i.e. an area of the substrate which is not to be cleaned. Even if the cleaning fluid is conveyed onto the substrate under pressure, the output of the pump 100 or of a corresponding other suctioning device is set such that the liquid is suctioned directly and completely in the manner described above. Applying the fluid under pressure is particularly advantageous if the distance between the flanges and the substrate is increased because with an increased distance an inproportionately high suctioning force would be necessary in order to achieve sufficient negative pressure at the outlet ports of the corresponding nozzle elements 50, 51.

Although this invention has been described by means of preferred embodiments of the invention, it is not limited to the specifically illustrated embodiments. In particular, the form of the nozzle elements can differ from the forms illustrated, and the attachment of the nozzle elements to the cleaning head can differ from the form of attachment illustrated.

1-44. (canceled)

45. A device for cleaning the edges of substrates, comprising:
at least one nozzle element for supplying medium to a substrate; and
at least one cleaning head adapted to receive said at least one nozzle element, wherein said at least one cleaning head comprises a main body in which is formed a medium-suctioning port and an adjoining medium-suctioning duct, wherein said at least one cleaning head further comprises at least one first flange extending from said main body and having a flat side that faces toward said medium-suctioning port and extends essentially perpendicular to a surface of said main body that contains said medium-suctioning port, wherein said at least one nozzle element is adapted to be provided on said at least one first flange so as to be spaced from said main body, wherein at least one nozzle element has at least one outlet port that is adapted to open in the direction that said flat side faces, wherein said at least one outlet port is directed substantially perpendicular to said flat side, wherein said at least one outlet port is recessed relative to said flat side or is flush therewith, and wherein during a cleaning process, said flat side is adapted to be spaced by 0.05 to 0.5 mm, especially up to 0.3 mm, and preferably by 0.2 mm from a surface of the substrate.

46. A device according to claim 45, which includes a movement mechanism for producing a relative movement between said at least one cleaning head and a substrate, wherein said movement mechanism is adapted to be controlled such that during the cleaning process it maintains the spacing between said flat side and the surface of the substrate.

47. A device according to claim 45, wherein said at least one cleaning head further comprises at least one second flange extending from said main body and having a flat side that faces toward said medium-suctioning port and extends essentially perpendicular to said surface of said main body that contains said medium-suctioning port, and wherein said flat sides of said at least one first flange and of said at least one second flange extend substantially parallel to one another and are spaced apart by a distance that is greater than a thickness of the substrate to be cleaned.

48. A device according to claim 47, wherein said flat sides are spaced apart by 0.1 to 1 mm, especially up to 0.6 mm, and preferably by 0.4 mm greater than the thickness of the substrate to be cleaned.

49. A device according to claim 47, which includes at least one further nozzle element for supplying medium, wherein said at least one further nozzle element is adapted to be provided on said at least one second flange so as to be spaced from said main body, wherein said at least one further nozzle element has at least one outlet port that is adapted to open in the direction that said flat side of said at least one second flange faces, wherein said at least one outlet port is directed substantially perpendicular to said flat side of said at least one second flange, and wherein said at least one outlet port is recessed relative to said flat side of said at least one second flange or is flush therewith.

50. A device according to claim 47, wherein said at least one cleaning head has a symmetrical construction relative to a plane that is centrally disposed between said flat sides of said at least one first flange and said at least one second flange.

51. A device according to claim 45, wherein said at least one nozzle element is pivotably disposed on said at least one first flange.

52. A device according to claim 51, wherein said at least one nozzle element is disposed on said at least one first flange so as to be pivotable between 0° and 40°, preferably between 0° and 20°, relative to a line that is perpendicular to said flat side of said at least one first flange.

53. A device according to claim 45, wherein said at least one nozzle element has a plurality of outlet ports or has a slit-shaped outlet port.

54. A device according to claim 53, wherein said plurality of outlet ports or said slit-shaped outlet port extends along a line that is parallel to said surface of said main body that contains said medium-suctioning port.

55. A device according to claim 45, wherein said at least one outlet port of said at least one nozzle element is spaced from said surface of said main body that contains said medium-suctioning port by a distance of between 2.5 and 6 mm, especially 3 mm.

56. A device according to claim 45, which includes at least one medium-supply means that communicates with said at least one nozzle element, and a control device (97) for regulating a supply of medium such that during the cleaning process, the medium is present at said at least one outlet port of said at least one nozzle element in a substantially unpresurrized state, or the medium is conveyed under pressure through the at least one nozzle element and is directed onto the substrate to be cleaned.

57. A device according to claim 56, wherein said medium is conveyed through said at least one nozzle element at a pressure of between 10 and 30 KPa, preferably 20 KPa.

58. A device according to claim 45, which includes a control device for separately controlling each nozzle element.

59. A device according to claim 45, wherein said at least one first flange is provided with a recess in which said at least one nozzle element is at least partially disposed.

60. A device according to claim 45, wherein said medium-suctioning port has a circular shape.

61. A device according to claim 45, wherein said medium-suctioning port has a diameter that is approximately 0.2 mm greater than a thickness of the substrate to be cleaned.

62. A device according to claim 45, wherein said medium-suctioning duct tapers away from said medium-suctioning port.

63. A device according to claim 45, which includes a suction device that is adapted to communicate with said medium-suctioning duct, and a control device for controlling said suction device.

64. A device according to claim 45, which includes a substrate support and a means for producing relative movement between said substrate support and said at least one cleaning head.

65. A device according to claim 45, which includes a control device for setting an overlap of said at least one first flange with a surface of the substrate to be cleaned.

66. A device according to claim 45, which includes a control device for controlling a relative movement between said at least one cleaning head and the substrate to be cleaned such that said at least one cleaning head travels along at least a portion of at least one edge of the substrate at a constant distance therefrom.

67. A method of cleaning substrates, including the steps of:
disposing a cleaning head having at least one nozzle element for supplying medium and at least one medium-suctioning port adjacent to a substrate to be cleaned such that said at least one nozzle element is directed toward at least one edge region of a side of the substrate to be cleaned and said medium-suctioning port is disposed in a region of said at least one nozzle element adjacent to an end face of the substrate, wherein a distance between a flat side of a flange of the cleaning head that carries said at least one nozzle element, and at least one edge region of the substrate to be cleaned, is set to 0.05 to 0.5 mm, especially up to 0.3 mm, and preferably 0.2 mm;
applying a cleaning fluid onto said at least one edge region of the substrate via said at least one nozzle element; and
completely suctioning the cleaning fluid off via said medium-suctioning port and an adjoining medium-suctioning duct.

68. A method according to claim 67, wherein said cleaning head is provided with at least two nozzle elements for supplying medium that face one another, wherein during said disposing step said at least one edge region of the substrate to be cleaned is disposed between said at least two nozzle elements, and wherein a distance between a flat side of a flange of said cleaning head that carries a second one of said nozzle elements, and the at least one edge region of the substrate to be cleaned, is set to 0.05 to 0.5 mm, especially up to 0.3 mm, and preferably 0.2 mm.

69. A method according to claim 67, which includes delivering the cleaning fluid to said at least one nozzle element such that the cleaning fluid is present at an outlet port thereof in an essentially unpressurized state and, via said medium-suctioning port and the adjoining medium-suctioning duct, is drawn out of said at least one nozzle element, and is applied to the at least one edge region of the substrate to be cleaned, essentially by the force of the suctioning.

70. A method according to claim 67, which includes applying the cleaning fluid with pressure through said at least one nozzle element onto at least one edge region of the substrate to be cleaned.

71. A method according to claim 70, wherein the pressure is in a range of between 10 and 30 KPa, preferably 20 KPa.

72. A method according to claim 67, which includes applying the cleaning fluid essentially perpendicular to the at least one edge region of the substrate, or applying the cleaning fluid to the at least one edge region of the substrate at an angle that deviates by 0 to 40°, preferably 0 to 20°, from a line that is perpendicular to the surface of the substrate.

73. A method according to claim 68, which includes separately controlling said nozzle elements.

74. A method according to claim 73, which includes operating said nozzle elements at different pressures, and/or supplying different fluids to said nozzle elements.

75. A method according to claim 67, which includes the further step of producing a relative movement between said cleaning head and the substrate such that said cleaning head moves along at least a portion of at least one edge of the substrate.

76. A method according to claim 75, which includes keeping a distance of said medium-suctioning port from an end face of the substrate constant during movement of said cleaning head.

77. A method according to claim 75, which includes effecting relative movement between the substrate and the cleaning head by movement of at least one of the substrate and said cleaning head.

78. A method according to claim 76, wherein the distance of the medium-suctioning port from the end face of the substrate is set between 0.5 and 2 mm, especially 1 mm, during a cleaning process.

79. A method according to claim 67, which includes cleaning between 2 and 5 mm, especially 3 mm, of an edge region of the substrate.

80. A method according to claim 67, which includes establishing a width of an edge region that is to be cleaned by setting an amount of overlap between said at least one nozzle element and a side surface of the substrate, or establishing a width of an edge region of the substrate to be cleaned at least partially by pivoting said at least one nozzle element.

81. A method according to claim 67, wherein, upon conclusion of a cleaning process, first the step of applying a cleaning fluid is terminated, and after a predetermined time interval after the termination of the applying step, the step of suctioning the cleaning fluid off is terminated.

82. A method according to claim 67, which includes controlling at least one of a supply of medium and suctioning off of cleaning fluid as a function of a contour of the substrate.

83. A method according to claim 67, which includes, when said at least one nozzle element reaches a region of a corner of a substrate, interrupting a supply of medium before said at least one nozzle element reaches the corner, while continuing the suctioning off of the cleaning fluid.
